(19) United States
(12) Patent Application Publication
(10) Pub. No.: US 2026/0160740 A1
(43) Pub. Date: Jun. 11, 2026

(54) THIN LAYER CHROMATOGRAPHY FRAME

(71) Applicant: BAYLOR UNIVERSITY, Waco, TX (US)

(72) Inventors: Bryan F. Shaw, Waco, TX (US); Levi Garza, Waco, TX (US); Roxane Marie Jourdain, Waco, TX (US)

(73) Assignee: BAYLOR UNIVERSITY, Waco, TX (US)

(21) Appl. No.: 19/179,443

(22) Filed: Apr. 15, 2025

Related U.S. Application Data
(60) Provisional application No. 63/634,208, filed on Apr. 15, 2024.

(51) Int. Cl. G01N 30/90; B01D 15/10

(52) U.S. Cl. CPC G01N 30/90; B01D 15/10

(57) ABSTRACT

The disclosure provides a thin layer chromatography (TLC) frame for allowing those with visual impairment to perform TLC. The TLC frame provides a structure that includes walls and stops to guide entry of a TLC plate for processing, asymmetrical guiding cones to funnel glass capillaries to correct positions, a solvent entry slit to guide solvent delivery for processing the TLC plate, and a tactile ruler for measuring the length of the reaction. Once complete, the TLC plate can be removed, the TLC frame cleaned if required, and another TLC plate inserted to perform the technique again. The invention will allow a brand-new field of researchers to perform experiments and contribute their time and effort.

### CROSS REFERENCE TO RELATED APPLICATIONS

This application claims the benefit of U.S. Provisional Application No. 63/634,208, filed Apr. 15, 2024, entitled “Thin Layer Chromatography Frame”, and is incorporated herein by reference.

### STATEMENT REGARDING FEDERALLY SPONSORED RESEARCH OR DEVELOPMENT

Not applicable

### REFERENCE TO APPENDIX

Not applicable

### BACKGROUND OF THE INVENTION

### Field of the Invention

The disclosure generally relates to equipment and related methods for chromatography. Specifically, the invention relates to equipment and related methods for chromatography to aid visually impaired users.

### Description of the Related Art

Thin Layer Chromatography (TLC) is an extremely useful technique utilized by organic chemistry labs all over the world. It allows researchers to separate the components of a mixture which yields valuable data. This technique is so prominent because of its simplicity, relatively low-cost, fast separation time, and high level of sensitivity. However, the problem is that researchers must load their samples onto the TLC plate very close to the edge. Usually, a line is drawn with a pencil that the samples will be loaded along to mark the starting point. The starting point is very important because the researchers depend on the distance traveled of their sample to obtain the data. This necessary precision has caused visually impaired, such as blind, researchers to be excluded from performing this technique because no assistive technology or tools have been created.

Therefore, there remains a need for equipment suitable for visually impaired users in the field to perform thin layer chromatography.

### BRIEF SUMMARY OF THE INVENTION

The disclosure provides a thin layer chromatography (TLC) frame for allowing those with visual impairment to perform TLC. The TLC frame provides a structure that includes walls and stops to guide entry of a TLC plate for processing, asymmetrical guiding cones to funnel glass capillaries to correct positions, a solvent entry slit to guide solvent delivery for processing the TLC plate, and a tactile ruler for measuring the length of the reaction. Once complete, the TLC plate can be removed, the TLC frame cleaned if required, and another TLC plate inserted to perform the technique again. The invention will allow a brand-new field of researchers to perform experiments and contribute their time and effort.

The disclosure provides a thin layer chromatography frame for processing samples, comprising: a housing comprising an entrance slide having side walls and a back wall; an elevated portion coupled to the side walls above the entrance slide forming a slot proximal to the back wall; at least one guide cone with a large end and a small end, the small end coupled to the elevated portion with at least one cone opening through the elevated portion aligned with the small end of the at least one guide cone, the slot sized to allow a sample plate to pass into the slot and under the at least one cone opening; and a solvent opening formed in the housing, fluidically coupled to the entrance slide and configured to allow liquid to flow into the slot and wet an area on the sample plate under the at least one cone opening.

The disclosure also provides a method of processing a sample for chromatography for a visually impaired user with a thin layer chromatography frame, comprising; inserting a sample plate into a slot of the frame; guiding placement of at least one sample using a guiding cone on the frame; flowing a liquid into a solvent opening in contact with at least a portion of the sample plate to process the sample plate; and analyzing the results of the sample.

### BRIEF DESCRIPTION OF THE SEVERAL VIEWS OF THE DRAWINGS

FIG. 1 is a schematic top perspective view of an embodiment of the invention for a thin layer chromatography frame.

FIG. 2A is a schematic top view of the TLC frame of FIG. 1.

FIG. 2B is a schematic bottom view of the TLC frame of FIG. 1.

FIG. 2C is a schematic left side view of the TLC frame of FIG. 1.

FIG. 2D is a schematic right side view of the TLC frame of FIG. 1.

FIG. 2E is a schematic back view of the TLC frame of FIG. 1.

FIG. 2F is a schematic front view of the TLC frame of FIG. 1.

FIG. 2G is a schematic front right perspective view of the TLC frame of FIG. 1.

FIG. 2H is a schematic back right perspective view of the TLC frame of FIG. 1.

FIG. 2I is a schematic back left perspective view of the TLC frame of FIG. 1.

FIG. 2J is a schematic front left perspective view of the TLC frame of FIG. 1.

FIG. 2K is a schematic front right perspective view of the TLC frame of FIG. 1.

FIG. 2L is a photograph of a front view of the TLC frame of FIG. 1.

FIG. 3A is a photograph of a user holding a TLC frame illustrated in FIG. 1 with one hand and inserting a TLC plate with the other hand into the TLC frame.

FIG. 3B is a photograph of the TLC plate midway into the TLC frame.

FIG. 3C is a photograph of the TLC plate back portion proximal to the guide cones of the TLC frame.

FIG. 3D is a photograph of the TLC plate fully inserted into the TLC frame.

FIG. 3E is a photograph of a user loading samples onto the TLC plate using the Guide Cones.

FIG. 3F is a photograph of equipment to run solvent across the TLC plate in the TLC Frame.

FIG. 3G is a photograph of an example of results from a solvent tested sample on the TLC plate in the TLC frame and analyzing the data with a UV light to reveal results.

### DETAILED DESCRIPTION

The Figures described above, and the written description of specific aspects and functions below are not presented to limit the scope of what Applicant has invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present disclosure will require numerous implementation-specific decisions to achieve the developer's goal for the commercial embodiment. Such implementation-specific decisions may include, and likely are not limited to, compliance with system-related, business-related, government-related, and other constraints, which may vary by specific implementation or location, or with time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a,” is not intended as limiting of the number of items. Further, the various methods and embodiments of the system can be included in combination with each other to produce variations of the disclosed methods and embodiments. Discussion of singular elements can include plural elements and vice-versa. References to at least one item may include one or more items. Also, various aspects of any embodiments could be used in conjunction with each other to accomplish the understood goals of the disclosure. Unless the context requires otherwise, the term “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The order of steps can occur in a variety of sequences unless otherwise specifically limited. The various steps described herein can be combined with other steps, interlineated with the stated steps, and/or split into multiple steps. Some elements are nominated by a device name for simplicity and would be understood to include a system or a section, such as having related components that are known to those with ordinary skill in the art and may not be specifically described. Various examples are provided in the description and figures that perform various functions and are non-limiting in shape, size, description, but serve as illustrative structures that can be varied as would be known to one with ordinary skill in the art given the teachings contained herein. The term “exemplary” as used herein is an adjective of “example” and is nonlimiting of other examples that are possible.

The current issue with TLC sampling is loading the samples onto the TLC plate with a glass capillary. These samples need to be loaded along a straight line because a distance that the sample travels is used to obtain the rf value. The disclosure provides a thin layer chromatography (TLC) frame for allowing those with visual impairment to perform TLC. The TLC frame provides a structure that includes walls and stops to guide entry of a TLC plate for processing, asymmetrical guiding cones to funnel glass capillaries to correct positions, a solvent entry slit to guide solvent delivery for processing the TLC plate, and a tactile ruler for measuring the length of the reaction. Once complete, the TLC plate can be removed, the TLC frame cleaned if required, and another TLC plate inserted to perform the technique again. The invention will allow a brand-new field of researchers to perform experiments and contribute their time and effort.

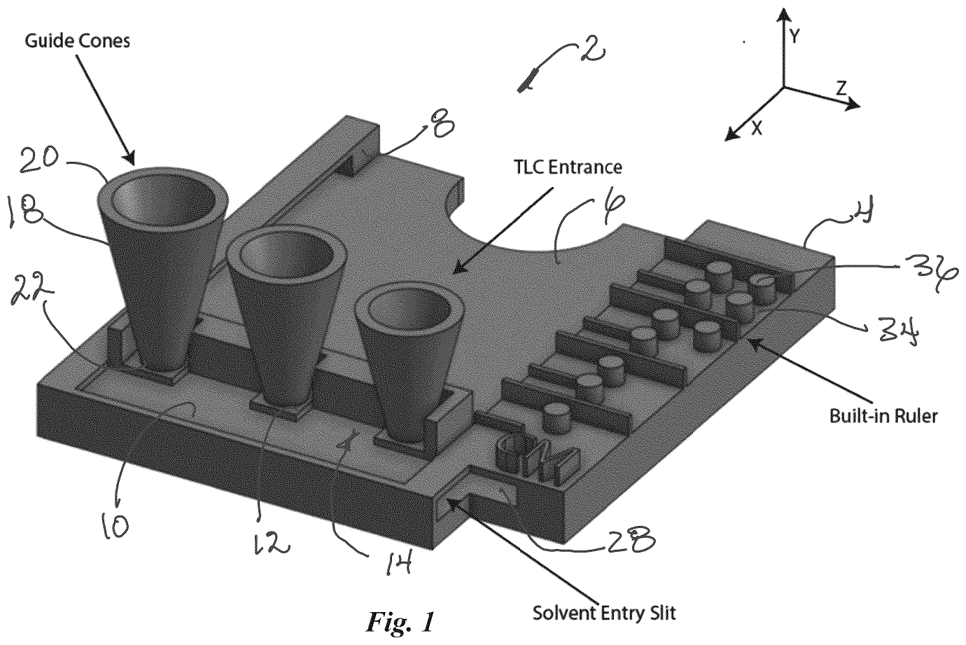

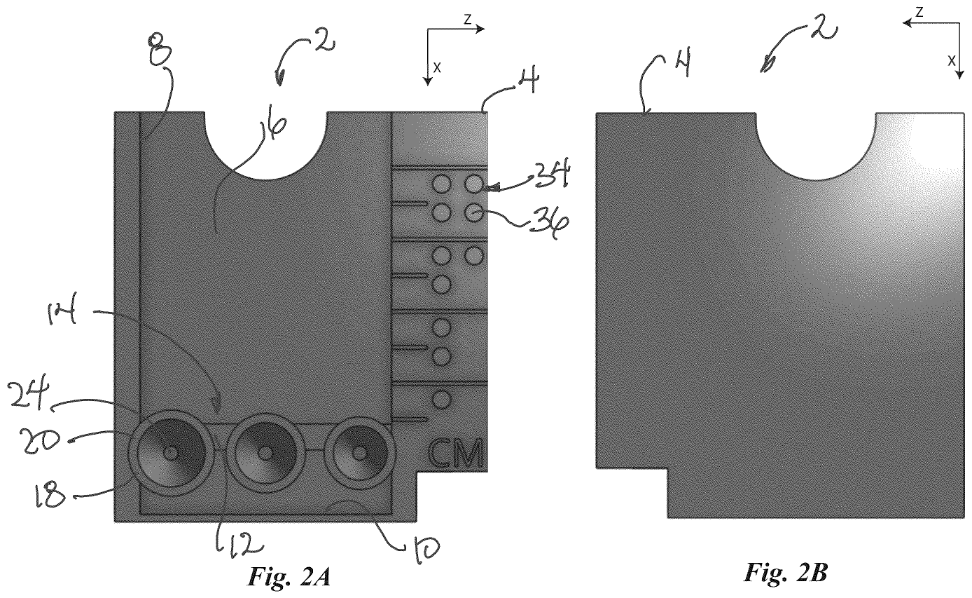

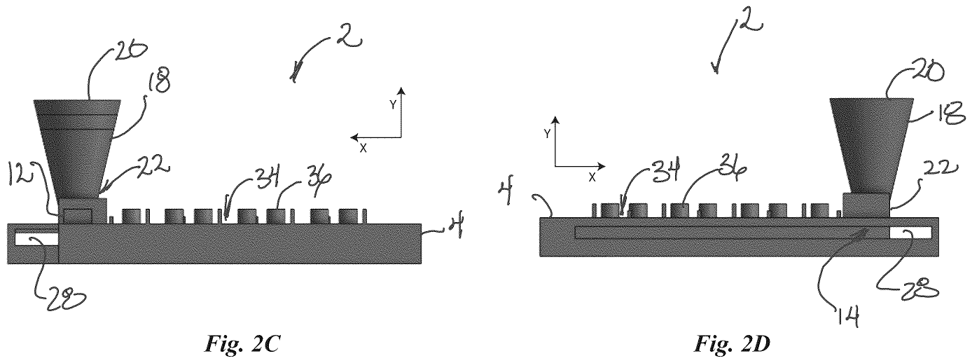

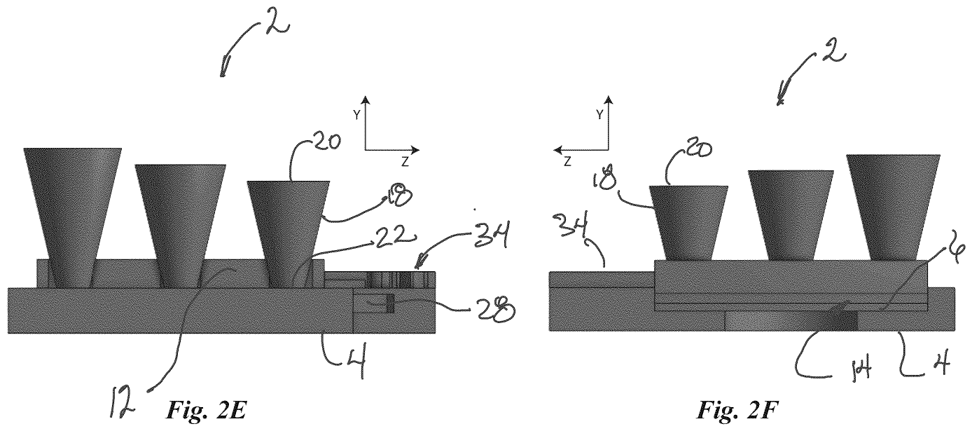

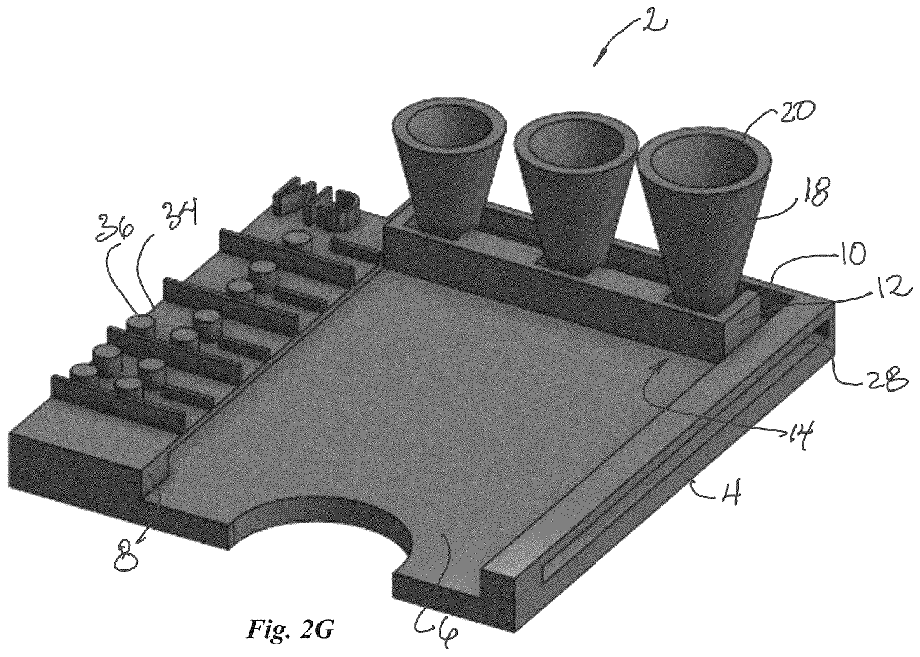

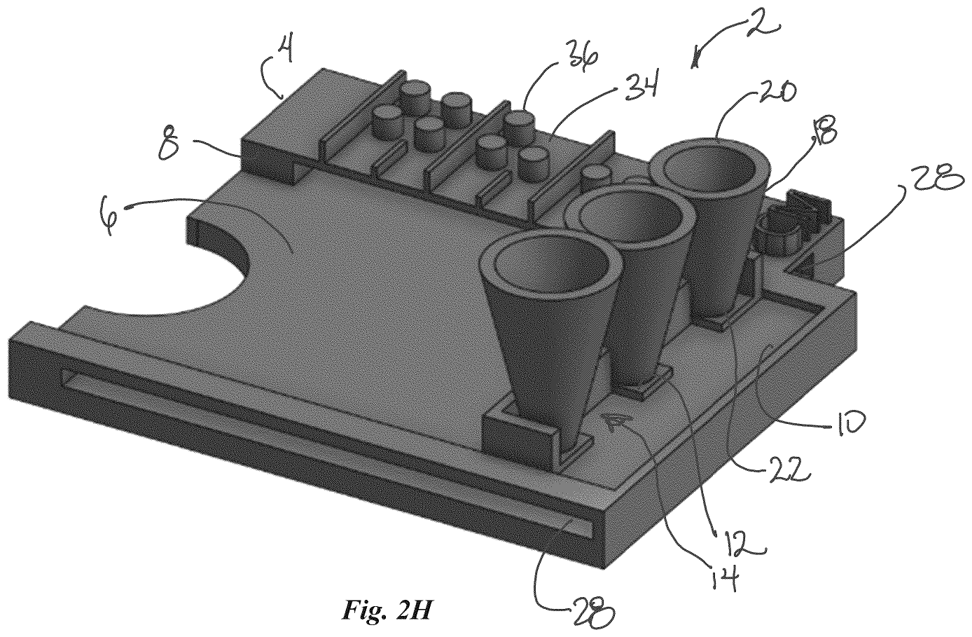

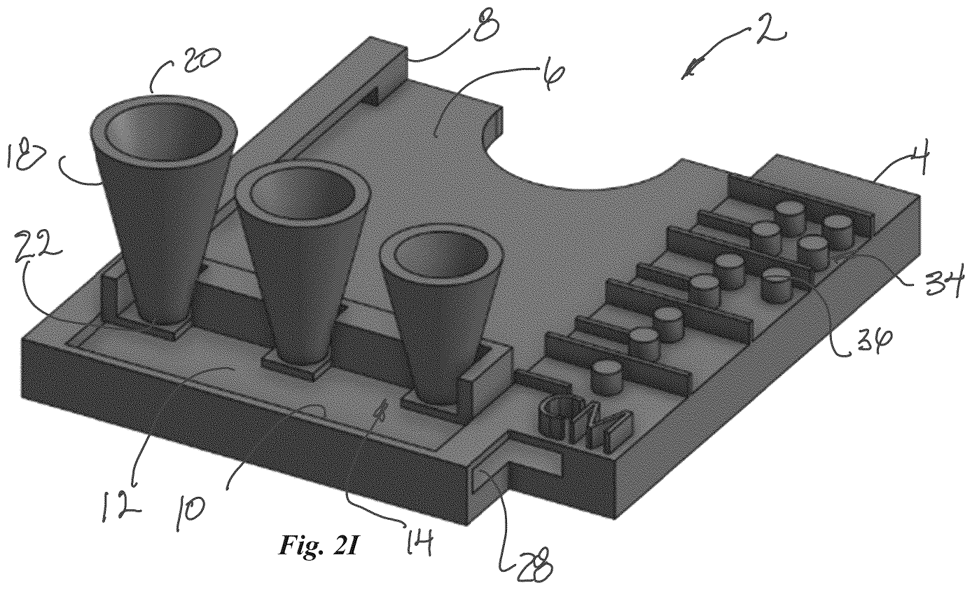

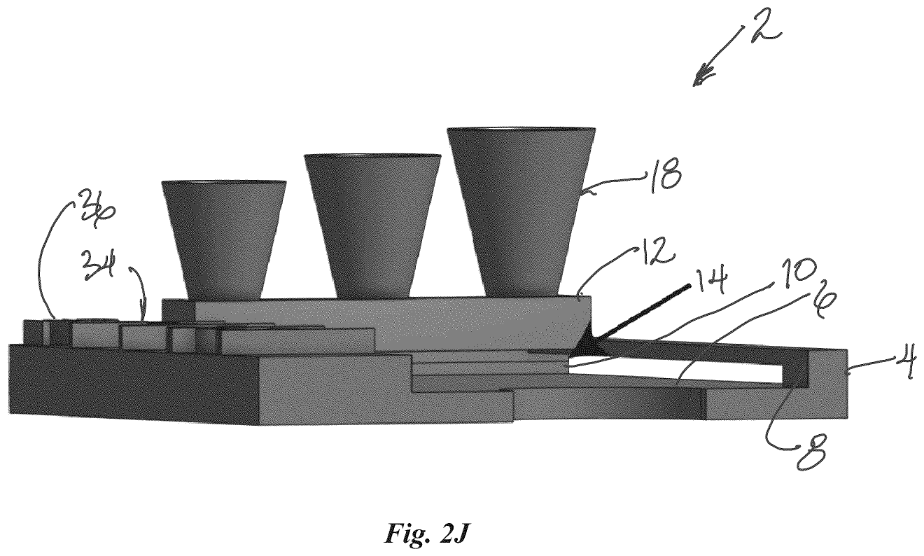

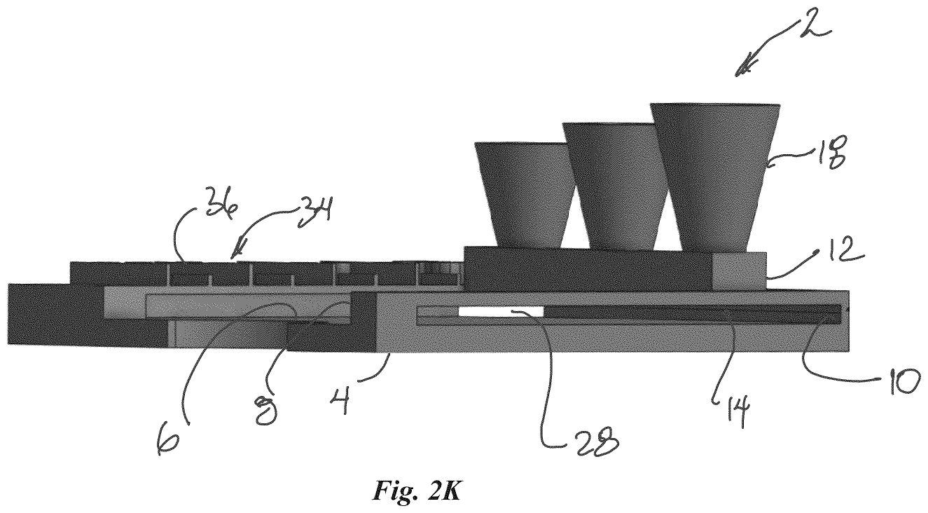

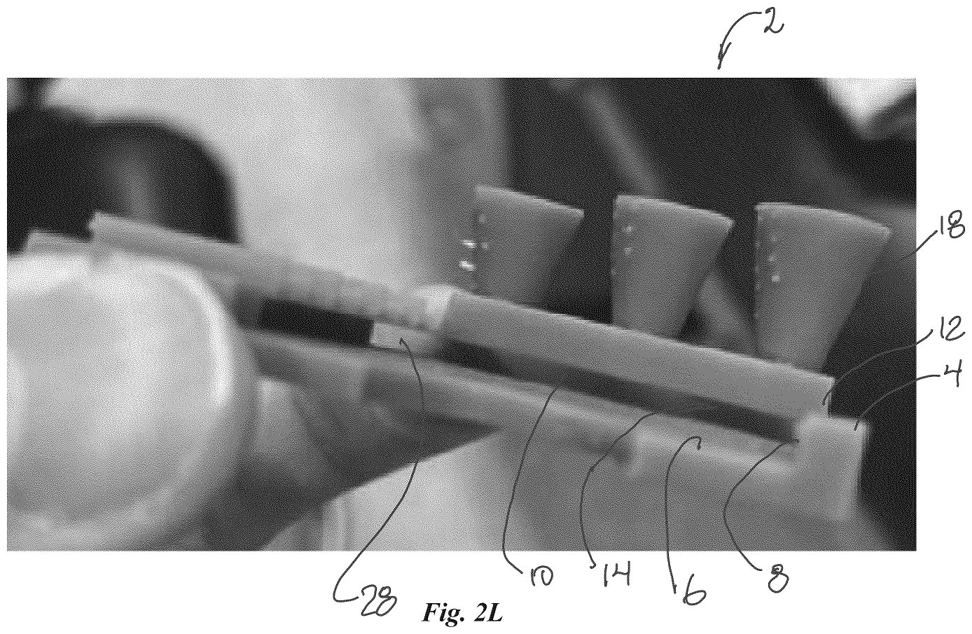

FIG. 1 is a schematic top perspective view of a nonlimiting embodiment of the invention for a thin layer chromatography (TLC) frame. FIG. 2A is a schematic top view of the TLC frame of FIG. 1. FIG. 2B is a schematic bottom view of the TLC frame of FIG. 1. FIG. 2C is a schematic left side view of the TLC frame of FIG. 1. FIG. 2D is a schematic right side view of the TLC frame of FIG. 1. FIG. 2E is a schematic back view of the TLC frame of FIG. 1. FIG. 2F is a schematic front view of the TLC frame of FIG. 1. FIG. 2G is a schematic front right perspective view of the TLC frame of FIG. 1. FIG. 2H is a schematic back right perspective view of the TLC frame of FIG. 1. FIG. 2I is a schematic back left perspective view of the TLC frame of FIG. 1. FIG. 2J is a schematic front left perspective view of the TLC frame of FIG. 1. FIG. 2K is a schematic front right perspective view of the TLC frame of FIG. 1. FIG. 2L is a photograph of a front view of the TLC frame of FIG. 1. The figures will be described in conjunction with each other.

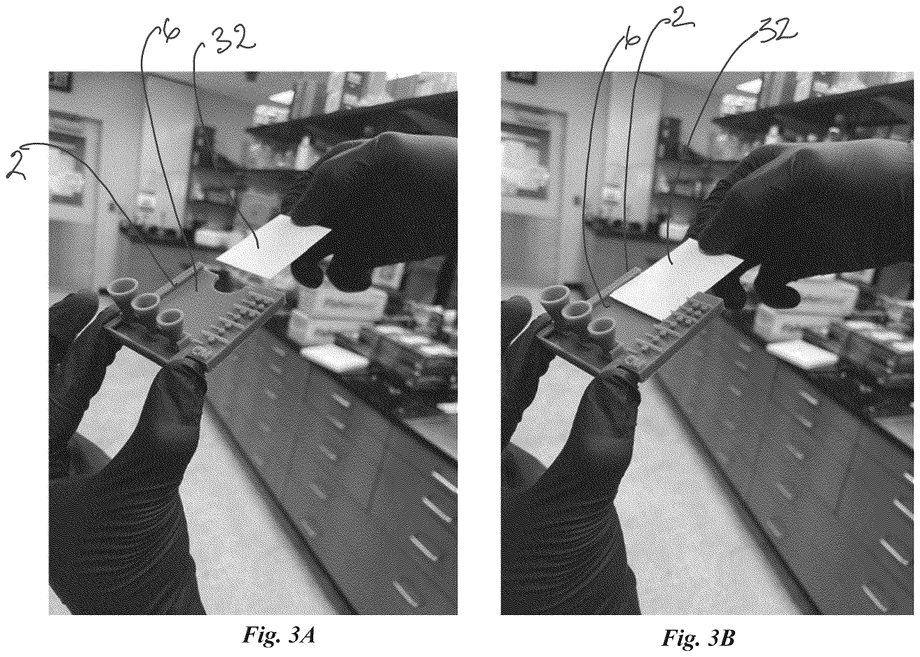

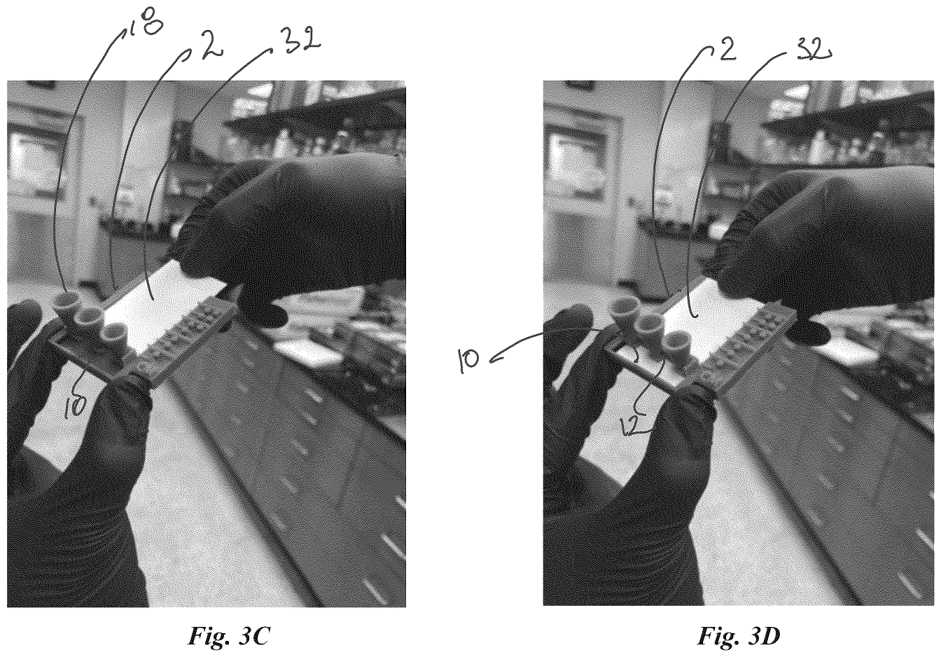

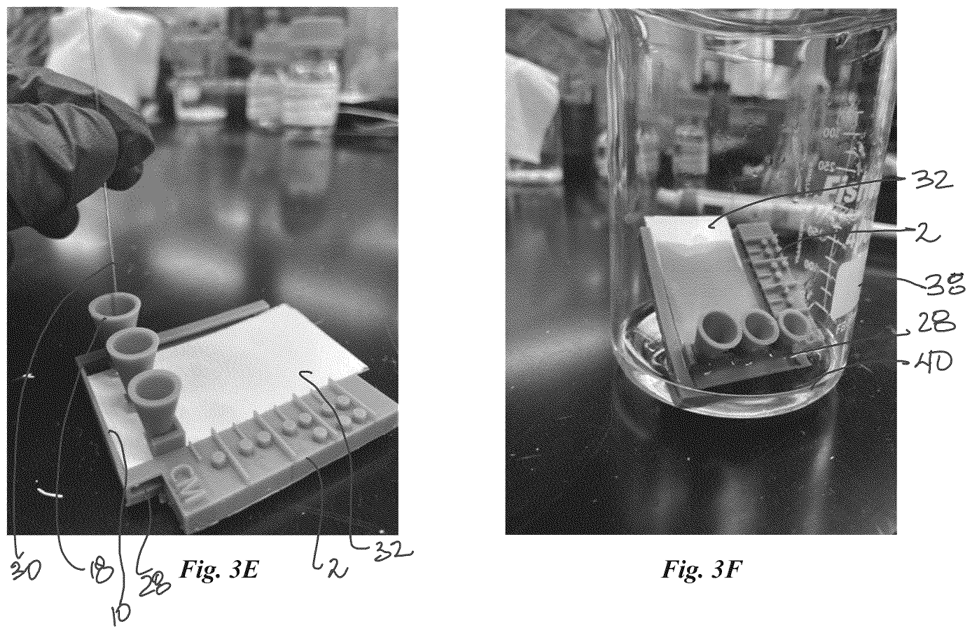

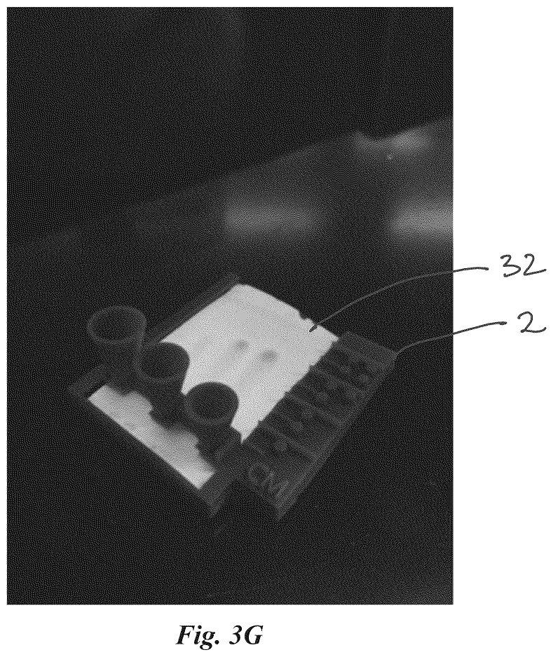

A Thin Layer Chromatography (TLC) frame 2 for processing samples can be made from any suitable material that is structurally sound and generally resistant to the chemical solvents used for the testing. The TLC frame 2 can be made by an additive manufacturing process. The TLC frame includes a housing 4 for supporting components coupled or formed on or in the housing. The housing 4 includes an entrance slide 6 suitable for supporting a sample plate 26 (shown in FIGS. 3A-3G) that can be placed on the entrance slide 6 in lateral and longitudinal alignment with components on the housing. To assist in the alignment, the housing 4 includes side walls 8 for lateral alignment of the sample plate and a back wall 10 to limit longitudinal movement of the sample card and longitudinal alignments with components, if needed. An elevated portion 12 proximal to the back wall can be coupled to the side walls 8 above the entrance slide forming a slot 14 between the entrance slide 6 and the elevated portion 12. Thus, the housing 4 forms an open space from the entrance slide 6 to the backwall 12 passing under the elevated portion 12. The slot 14 is sized to allow the sample plate 26 to pass through the slot and extend to the back wall 10.

At least one guide cone 18 can be coupled to the elevated portion 12. The guide cone is formed with an open large end 20 distal from the elevated portion 12 that reduces to a small end 22 proximal to the elevated portion and the slot 14. The cone small end 22 has at least one cone opening 24 that extends through the elevated portion 12 into fluidic communication with the slot. The cone 18 with the progressive constriction toward the cone opening 24 is used to guide a deposit of substances to correct positions and alignments through the cone opening 24 onto the sample plate 26, even for visually impaired users. A lateral solvent opening 28 is formed in the housing 4, generally through at least one sidewall 8 and preferably both side walls. The solvent opening 28 is fluidically coupled to the slot 14 and the entrance slide 6 and configured to allow liquid to flow into the slot and wet an area containing the sample plate under the at least one cone opening. When the solvent opening is through both side walls as illustrated, solvent can enter from the left and right side of the housing. Additionally, solvent can enter from above the back wall if submerged in enough solvent.

To assist visually impaired users, the housing can be formed with a ruler 34 with appropriate indicators 36 for position. For example, a longitudinal position can be marked along the ruler 34 in centimeters or inches with indicators 36 designative of the position.

For an exemplary method of use, the TLC plate is first slid into the device along the entrance slide 6 and through the slot 14 until the front end of the TLC sample plate 26 reaches the back wall 10 proximal to the solvent opening 28. Once the TLC has been inserted, a glass capillary with a corresponding sample can be loaded onto the plate by using the guide cone 18. The guide cone helps funnel the glass capillary through the opening 24 to a correct spot on the TLC sample plate. Advantageously, each guide cone can be in a single line, so all samples have the same longitudinal starting site. Furthermore, the guide cones can decrease in height to give the device an asymmetrical shape to help the researcher distinguish between left and right and decrease the possibility of incorrect loading, even for visually impaired users. Once the samples have been loaded, the TLC sample plate can be processed in the device. The solvent opening 28 provides an opening where the solvent can wet the TLC plate that is encapsulated in the TLC frame 2 and flow through the housing. Once the reaction is complete, any appropriate marker can be used to spot the sample on the sample plate. The distance that the sample traveled can be measured with the integrated ruler that is on the side of the sample. For example, a sequence of small lines each indicates half a centimeter, and a sequence of a full line indicates a centimeter from the middle of the at least one guiding cone. As a further example, indicators 36, such as circles, indicate a particular centimeter position such as 1, 2, 3, and 4 centimeters. Once testing is complete, the TLC plate can be removed and replaced with another TLC plate to perform this technique again.

FIG. 3A is a photograph of a user holding a TLC frame of the embodiment illustrated in FIG. 1 with one hand and inserting a TLC plate with the other hand into the TLC frame. FIG. 3B is a photograph of the TLC plate midway into the TLC frame. FIG. 3C is a photograph of the TLC plate back portion proximal to the Guiding Cones of the TLC frame. FIG. 3D is a photograph of the TLC plate fully inserted into the TLC frame. FIG. 3E is a photograph of a user loading samples onto the TLC plate using the Guide Cones. FIG. 3F is a photograph of equipment to provide solvent across the TLC plate in the TLC Frame. FIG. 3G is a photograph of an example of results from a solvent tested sample on the TLC plate in the TLC frame and analyzing the data with a UV light to reveal results.

The method generally includes inserting the TLC sample plate 26 into the TLC frame 2 until the TLC plate is fully inserted against the back wall 10. A sample in a glass capillary can be guided with a guide cone 18 for an aligned placement of the sample through an opening 24 onto on the TLC plate 26. A solvent used for initiating the processing can be provided, such as flowing the solvent into the housing through a solvent opening 28 across the TLC plate portion with the sample or such portion being immersed in the solvent, or other methods as known in the art. Multiple cones, multiple opening through the cones to the slot, and multiple samples can be processed together for comparative analysis and other purposes.

Other and further embodiments utilizing one or more aspects of the inventions described above can be devised without departing from the disclosed invention as defined in the claims. For example, different numbers of cones can be provided, different ruler indicia, and different shaped entrances for the TLC plates can be provided, among other contemplated variations.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intends to protect fully all such modifications and improvements that come within the scope of the following claims.

What is claimed is:

1. A thin layer chromatography frame 2 for processing samples, comprising:
a housing 4 comprising an entrance slide 6 having side walls 8 and a back wall 10;
an elevated portion 12 coupled to the side walls above the entrance slide forming a slot 14 proximal to the back wall;
at least one guide cone 18 with a large end 20 and a small end 22, the small end coupled to the elevated portion with at least one cone opening 24 through the elevated portion aligned with the small end of the at least one guide cone, the slot 14 sized to allow a sample plate 26 to pass into the slot and under the at least one cone opening 24; and
a solvent opening 28 formed in the housing, fluidically coupled to the entrance slide and configured to allow liquid to flow into the slot and wet an area on the sample plate under the at least one cone opening.

2. The frame of claim 1, further comprising a plurality of guide cones having different heights to distinguish based on tactile senses.

3. The frame of claim 1, further comprising a ruler 34 coupled to the housing that indicates distance along the entrance slide.

4. A method of processing a sample for chromatography for a visually impaired user with a thin layer chromatography frame, comprising;
inserting a sample plate 26 into a slot 14 of the frame 2;
guiding placement of at least one sample using a guiding cone 18 on the frame;
flowing a liquid into a solvent opening 28 in contact with at least a portion of the sample plate 26 to process the sample plate; and
analyzing the results of the sample.

5. The method of claim 4, wherein the method is configured to be performed by the visually impaired person.

6. The method of claim 4, wherein the frame comprises a plurality of guide cones of different sizes for processing a plurality of samples on the sample plate, the guide cones configured to be distinguished by shape by a visually impaired person.
